(19) United States
(12) Patent Application Publication
(10) Pub. No.: US 2024/0039096 A1
(43) Pub. Date: Feb. 1, 2024

(54) GASKET AND CYLINDRICAL BATTERY

(71) Applicant: SANYO Electric Co., Ltd., Osaka (JP)

(72) Inventors: Yuma Yamaguchi, Osaka (JP); Shuji Sugimoto, Hyogo (JP)

(73) Assignee: SANYO Electric Co., Ltd., Osaka (JP)

(21) Appl. No.: 18/022,395

(22) PCT Filed: Aug. 26, 2021
(86) PCT No.: PCT/JP2021/031276

§ 371 Date: Feb. 21, 2023

(30) Foreign Application Priority Data
Aug. 31, 2020 (JP) 2020-145694

(51) Int. Cl. H01M 50/184; H01M 50/107; H01M 50/152; H01M 50/578; H01M 50/186; H01M 50/342

(52) U.S. Cl. CPC H01M 50/184; H01M 50/107; H01M 50/152; H01M 50/578; H01M 50/186; H01M 50/3425

(57) ABSTRACT

Provided are a highly reliable cylindrical battery and the like which exhibit a small variation in operation pressure of a current cutoff mechanism. A cylindrical battery comprises a current cutoff mechanism having a sealing body which includes a terminal plate for cutting off flowing of current by being broken. A gasket of the cylindrical battery has, in an independent state before incorporation into an exterior can, a cylindrical part and an annular part which extends from an end at a first axial side of the cylindrical part to the radially inner side. The annular part has, at a radially inner side portion of a surface at the first axial side, a recess recessed toward a second axial side.

### TECHNICAL FIELD

The present disclosure relates to a gasket and a cylindrical battery.

### BACKGROUND

In the related art, cylindrical batteries are known such as that described in Patent Literature 1. The cylindrical battery includes an electrode assembly in which a positive electrode and a negative electrode are wound with a separator interposed therebetween, an electrolyte, an outer housing can having a tubular shape with a bottom and which houses the electrode assembly and the electrolyte, a sealing assembly, and an annular gasket having a sandwiched part sandwiched by the outer housing can and the sealing assembly and which insulates the sealing assembly with respect to the outer housing can. On the outer housing can, a groove which extends in a circumferential direction is provided on an outer circumferential surface so that a protrusion which protrudes to an inner side in a radial direction is formed on an inner circumferential side.

An end of the outer housing can on a side of an opening is crimped on the side of the sealing assembly by folding an inner side of the end, so that the sealing assembly is sandwiched by the protrusion and the crimping part of the outer housing can along with the gasket, and fixed on the outer housing can. The sealing assembly has a current breaker mechanism. More specifically, when abnormal heat generation occurs in the cylindrical battery, gas is generated in the battery and an internal pressure is increased. The current breaker mechanism has a rupturing part which ruptures when the internal pressure becomes excessive during abnormal heat generation of the battery, and the rupturing part ruptures to thereby cut off the current.

### CITATION LIST

### Patent Literature

PATENT LITERATURE 1: JP H09-320562 A

### SUMMARY

### Technical Problem

The present inventors noticed the following problem. Specifically, as shown in FIG. 7, a sealing assembly 317 is crimped during sealing and assembled to a cylindrical battery 310. However, during the crimping, a significant pressure acts on the sealing assembly 317, a gasket 328, and an outer housing can 316, and the sealing assembly 317 deforms due to application of a stress in a circumferential direction during the crimping. That is, during the crimping, a vent cap 327 provided in the sealing assembly 317 experiences a force toward an inner side in a radial direction and deforms, resulting in a reduced inner size of the vent cap 327, and, more specifically, a reduced presser size of the vent cap 327 in the inner circumferential side.

With such a background, in the vent cap, as an inner size difference of a surface which contacts a safety vent (rupture) is increased, variation of an operation pressure of the current breaker mechanism is increased, resulting in reduction of reliability of the cylindrical battery. More specifically, when the inner size of the vent cap is small and a size of a contacting part with the safety vent is small, the operation pressure of the current breaker mechanism tends to become high. When the inner size of the vent cap is large and the size of the contact part with the safety vent is large, the operation pressure of the current breaker mechanism tends to become low.

An advantage of the present disclosure lies in provision of a gasket which can form a highly reliable cylindrical battery by reducing the variation of the operation pressure of the current breaker mechanism, and in provision of a highly reliable cylindrical battery in which the variation of the operation pressure of the current breaker mechanism can be reduced.

### Solution to Problem

According to one aspect of the present disclosure, there is provided a gasket for a cylindrical battery, the gasket including: a tubular part; and a circular annular part that extends from an end on a first side in an axial direction of the tubular part toward an inner side in a radial direction, wherein the circular annular part has a recess which is recessed to a second side in the axial direction, on an inner side in the radial direction of a surface on the first side in the axial direction.

According to another aspect of the present disclosure, there is provided a cylindrical battery including: an electrode assembly in which a positive electrode and a negative electrode are wound with a separator interposed therebetween, an electrolyte, an outer housing can having a tubular shape with a bottom and that houses the electrode assembly and the electrolyte; a sealing assembly; and an annular gasket that includes a sandwiched part which is sandwiched by the outer housing can and the sealing assembly, and that insulates the sealing assembly with respect to the outer housing can, wherein the sealing assembly includes a current breaker mechanism having a rupturing part which ruptures to cut off a flow of current, and, in a singular state before the gasket is incorporated into the outer housing can, the gasket has a tubular part, and a circular annular part which extends from an end on a first side in an axial direction of the tubular part toward an inner side in a radial direction, wherein the circular annular part has a recess which is recessed to a second side in the axial direction, on an inner side in the radial direction of a surface on the first side in the axial direction.

The above-described tubular part may have a cylindrical shape or a non-cylindrical shape. For example, the tubular part may have a shape of a truncated cone, and may have an annular structure with an inner circumferential surface of a cylinder and an outer circumferential surface of the truncated cone having a same central axis as a central axis of the cylinder. That is, it is sufficient that the tubular part has an annular structure in which a minimum inner size thereof is larger than a maximum inner size of the circular annular portion. The second side in the axial direction is a side opposite from the first side in the axial direction. The “singular state before incorporated into the outer housing can” refers to a state before the gasket is integrated with the sealing assembly and the outer housing can, and in which the gasket exists as a single entity without contacting the sealing assembly and the outer housing can.

### Advantageous Effects

According to a gasket of the present disclosure, the variation of the operation pressure of the current breaker mechanism can be reduced and a highly reliable cylindrical battery can be formed. Further, according to the cylindrical battery of the present disclosure, the variation of the operation pressure of the current breaker mechanism can be reduced and the reliably of the battery can be improved.

### BRIEF DESCRIPTION OF DRAWINGS

FIG. 1 is a cross-sectional diagram in an axial direction of a cylindrical battery according to an embodiment of the present disclosure.

FIG. 2 is a perspective diagram of an electrode assembly of the cylindrical battery.

FIG. 3(a) is an enlarged cross-sectional diagram around a sealing assembly before operation of a current breaker mechanism of the cylindrical battery.

FIG. 3(b) is an enlarged cross-sectional diagram around the sealing assembly after the operation of the current breaker mechanism.

FIG. 4 is a cross-sectional diagram of a one-side portion positioned on one side of a central axis of a gasket according to an embodiment of the present disclosure, before being incorporated into an outer housing can.

FIG. 5 is a diagram showing results of analysis, using a simulation model, of transition of deformation for various degrees of crimping of a gasket, for each of a gasket with an annular recess, a gasket of Comparative Example 1 having no recess, and a gasket of Comparative Example 2 having no recess.

FIG. 6 is a diagram showing a simulation result showing a stress distribution after crimping, for the cylindrical batteries of Example, Comparative Example 1, and Comparative Example 2 used for the analysis of FIG. 5.

FIG. 7 is a diagram explaining the crimping process of the cylindrical battery.

### DESCRIPTION OF EMBODIMENTS

A gasket and a cylindrical battery according to an embodiment of the present disclosure will now be described in detail with reference to the drawings. The cylindrical battery of the present disclosure may be a primary battery or a secondary battery. Further, the cylindrical battery of the present disclosure may be a battery which uses an aqueous electrolyte or a battery which uses a non-aqueous electrolyte. In the following description, a non-aqueous electrolyte secondary battery which uses a non-aqueous electrolyte (lithium ion battery) will be exemplified as a cylindrical battery 10 according to an embodiment of the present disclosure, but the cylindrical battery of the present disclosure is not limited to such a battery.

In the following description, when a plurality of embodiments and alternative configurations are included, a new embodiment constructed by combining characteristic portions of these embodiments and alternative configurations are presumed from the start. In addition, in the following embodiment, the same structures in the drawings are assigned the same reference numerals, and repeated description thereof will not be given. Further, the plurality of drawings include schematic drawings, and dimension ratios such as a horizontal size, a lateral size, a height, and the like among various members do not necessarily coincide with each other over different drawings. Moreover, in the present disclosure, for convenience of the description, a direction along an axial direction of a battery casing 15 will be referred to as a height direction, a side of a sealing assembly 17 in the height direction will be referred to as an “upper” side, and a side of a bottom of an outer housing can 16 in the height direction will be referred to as a “lower” side. Among the constituting elements described below, constituting elements that are not described in an independent claim describing the broadest concept are optional constituting elements, and are not necessary constituting elements.

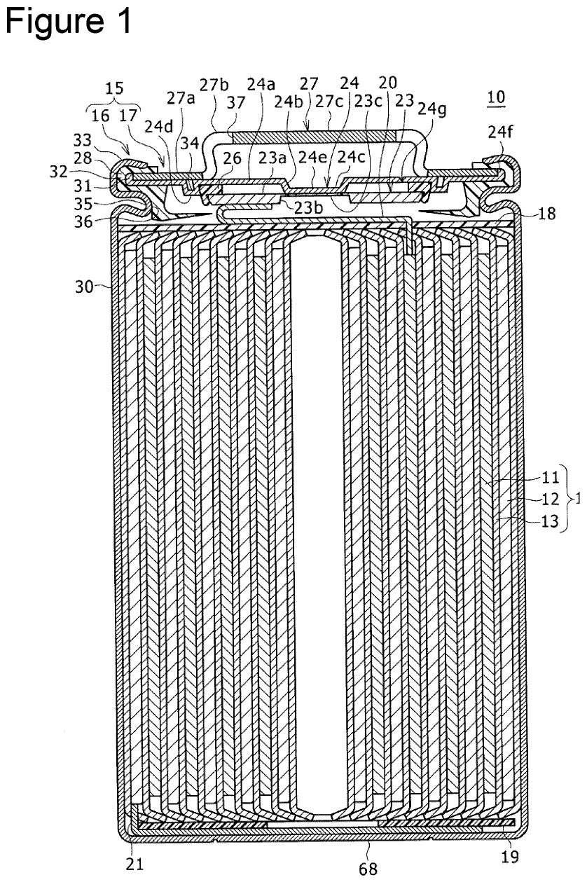

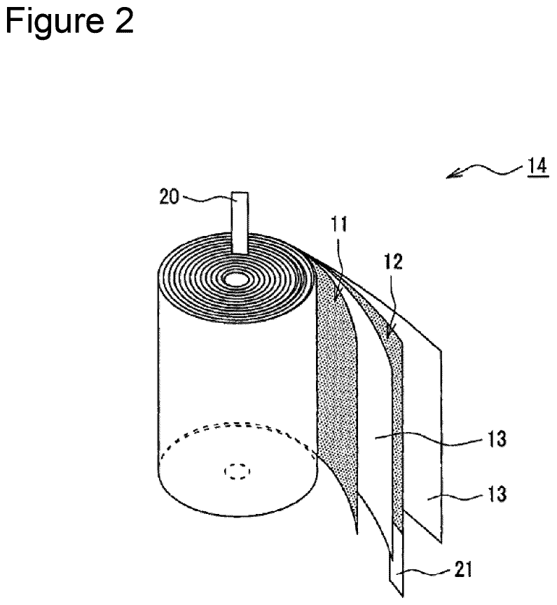

FIG. 1 is a cross-sectional diagram in an axial direction of the cylindrical battery 10 according to an embodiment of the present disclosure. FIG. 2 is a perspective diagram of an electrode assembly 14 of the cylindrical battery 10. As shown in FIG. 1, the cylindrical battery 10 comprises an electrode assembly 14 of a winding type, a non-aqueous electrolyte (not shown), and the battery casing 15 which houses the electrode assembly 14 and the non-aqueous electrolyte. As shown in FIG. 2, the electrode assembly 14 comprises a positive electrode 11, a negative electrode 12, and a separator 13 interposed between the positive electrode 11 and the negative electrode 12, and has a wound structure in which the positive electrode 11 and the negative electrode 12 are wound with the separator interposed therebetween. Referring again to FIG. 1, the battery casing 15 is formed from an outer housing can 16 having a tubular shape with a bottom, and the sealing assembly 17 which blocks an opening of the outer housing can 16. The cylindrical battery 10 further comprises a gasket 28 made of a resin, which is placed between the outer housing can 16 and the sealing assembly 17.

The non-aqueous electrolyte includes a non-aqueous solvent, and an electrolyte salt dissolved in the non-aqueous solvent. For the non-aqueous solvent, for example, esters, ethers, nitriles, amides, or a mixed solvent of two or more of these solvents may be used. The non-aqueous solvent may include a halogen-substituted product in which at least a part of hydrogens of the solvent is substituted with a halogen atom such as fluorine. The non-aqueous electrolyte is not limited to a liquid electrolyte, and may alternatively be a solid electrolyte which uses a gel-form polymer or the like. For the electrolyte salt, a lithium salt such as LiPF₆ is used.

As shown in FIG. 2, the electrode assembly 14 comprises the positive electrode 11 of an elongated shape, the negative electrode 12 of an elongated shape, and two separators 13 of an elongated shape. Further, the electrode assembly 14 has a positive electrode lead 20 joined to the positive electrode 11, and a negative electrode 21 joined to the negative electrode 12. The negative electrode 12 is formed in a size slightly larger than that of the positive electrode 11 in order to suppress precipitation of lithium, and is formed longer in a longitudinal direction and in a width direction (short-side direction) than the positive electrode 11. The two separators 13 are formed in a size slightly larger than at least the positive electrode 11, and are placed, for example, to sandwich the positive electrode 11.

The positive electrode 11 comprises a positive electrode current collector and positive electrode mixture layers formed over both surfaces of the positive electrode current collector. For the positive electrode current collector, there may be employed a foil of a metal which is stable within a potential range of the positive electrode 11 such as aluminum and an aluminum alloy, a film on a surface layer of which the metal is placed, or the like. The positive electrode mixture layer includes a positive electrode active material, a conductive agent, and a binder agent. The positive electrode 11 can be produced, for example, by applying a positive electrode mixture slurry including the positive electrode active material, the conductive agent, the binder agent, or the like over the positive electrode current collector, drying the applied film, and compressing the dried film to form the positive electrode mixture layer over both surfaces of the current collector.

The positive electrode active material is formed with a lithium-containing metal composite oxide as a primary constituent. As metal elements contained in the lithium-containing metal composite oxide, there may be exemplified Ni, Co, Mn, Al, B, Mg, Ti, V, Cr, Fe, Cu, Zn, Ga, Sr, Zr, Nb, In, Sn, Ta, W, and the like. A desirable example of the lithium-containing metal composite oxide is a composite oxide containing at least one of Ni, Co, Mn, and Al.

As the conductive agent included in the positive electrode mixture layer, there may be exemplified carbon materials such as carbon black, acetylene black, Ketjenblack, graphite, and the like. As the binder agent included in the positive electrode mixture layer, there may be exemplified a fluororesin such as polytetrafluoroethylene (PTFE), polyvinylidene fluoride (PVdF), or the like, polyacrylonitrile (PAN), polyimide, an acrylic resin, polyolefin, or the like. Alternatively, a cellulose derivative such as carboxymethyl cellulose (CMC) or a salt thereof, or polyethylene oxide (PEO) or the like may be used along with the above-described resins.

The negative electrode 12 comprises a negative electrode current collector and a negative electrode mixture layer formed over both surfaces of the negative electrode current collector. For the negative electrode current collector, there may be employed a foil of a metal which is stable within a potential range of the negative electrode 12 such as copper and a copper alloy, a film on a surface layer of which the metal is placed, or the like. The negative electrode mixture layer includes a negative electrode active material and a binder agent. The negative electrode 12 can be produced, for example, by applying a negative electrode mixture slurry including the negative electrode active material, the binder agent, or the like over the negative electrode current collector, drying the applied film, and compressing the dried film, to form the negative electrode mixture layer over both surfaces of the current collector.

As the negative electrode active material, in general, a carbon material which reversibly occludes and releases lithium ions is used. Desirable examples of the carbon material include graphite such as natural graphite such as flake graphite, massive graphite, amorphous graphite, or the like, and artificial graphite such as massive artificial graphite, graphitized meso-phase carbon microbeads, or the like. Alternatively, an Si-containing compound may be contained in the negative electrode mixture layer as the negative electrode active material. Alternatively, a metal other than Si and which alloys with lithium, an alloy containing such a metal, a compound containing such a metal, or the like may be used as the negative electrode active material.

As the binder agent included in the negative electrode mixture layer, similar to the case of the positive electrode 11, a fluororesin, PAN, a polyimide resin, an acrylic resin, a polyolefin resin, or the like may be employed, but desirably, styrene-butadiene rubber (SBR) or an altered material thereof is employed. The negative electrode mixture layer may contain, in addition to SBR or the like, CMC or a salt thereof, a polyacrylic acid (PAA) or a salt thereof, polyvinyl alcohol, or the like.

For the separator 13, a porous sheet having an ion permeability and an insulating property is employed. Specific examples of the porous sheet include a microporous thin film, a woven fabric, a non-woven fabric, or the like. As a material forming the separator 13, desirably, an olefin resin such as polyethylene, polypropylene, or the like, cellulose, or the like is employed. The separator 13 may have a single-layer structure or a layered structure. On a surface of the separator 13, a heat resistive layer or the like may be formed. The negative electrode 12 may form a winding start end of the electrode assembly 14, but in general, the separator 13 extends beyond a winding start side end of the negative electrode 12, and a winding start side end of the separator 13 becomes the winding start end of the electrode assembly 14.

In the illustrated example configuration of FIGS. 1 and 2, the positive electrode lead 20 is electrically connected to an intermediate portion such as a center part in a winding direction of a positive electrode core, and the negative electrode lead 21 is electrically connected to a winding completion end in the winding direction of a negative electrode core. Alternatively, the negative electrode lead may be electrically connected to a winding start end in the winding direction of the negative electrode core. Alternatively, the electrode assembly may have two negative electrode leads, one of the negative electrode leads may be electrically connected to the winding start end in the winding direction of the negative electrode core, and the other negative electrode lead may be electrically connected to the winding completion end in the winding direction of the negative electrode core. Alternatively, the winding completion side end in the winding direction of the negative electrode core may be contacted with an inner surface of the outer housing can, so as to electrically connect the negative electrode and the outer housing can.

As shown in FIG. 1, the cylindrical battery 10 comprises an insulating plate 18 placed above the electrode assembly 14, and an insulating plate 19 placed below the electrode assembly 14. In the example structure illustrated in FIG. 1, the positive electrode lead 20 attached to the positive electrode 11 extends through a through hole of the insulating plate 18 toward the side of the sealing assembly 17, and the negative electrode lead 21 attached to the negative electrode 12 extends toward the side of a bottom 68 of the outer housing can 16 through an outer side of the insulating plate 19. The positive electrode lead 20 is connected to a lower surface of a terminal plate 23 which is a bottom plate of the sealing assembly 17 by welding or the like, and a vent cap 27 which is a top plate of the sealing assembly 17 electrically connected to the terminal plate 23 serves as a positive electrode terminal. The negative electrode lead 21 is connected to an inner surface of the bottom 68 of the outer housing can 16 by welding or the like, and the outer housing can 16 serves as a negative electrode terminal. The structure of the sealing assembly 17 will be described later in detail.

The outer housing can 16 is a metal container having a tubular shape with a bottom. A region between the outer housing can 16 and the sealing assembly 17 is hermitically sealed with an annular gasket 28, and an internal space of the battery casing 15 is tightly sealed by the hermitical sealing. The gasket 28 includes a sandwiched part 32 which is sandwiched by the outer housing can 16 and the sealing assembly 17, and insulates the sealing assembly 17 with respect to the outer housing can 16. The gasket 28 has a role of a sealing member for maintaining airtightness inside the battery, and also a roll of preventing leakage of the electrolyte solution. The gasket 28 further has a role as an insulating member which prevents short-circuiting between the outer housing can 16 and the sealing assembly 17.

The outer housing can 16 has, on an inner circumferential side thereof, a protrusion 36 which protrudes toward an inner side in the radial direction by providing an annular groove 35 at a part, in a height direction, of an outer circumferential surface of the cylinder of the outer housing can 16. The annular groove 35 may be formed, for example, by recessing a part of the circumferential surface of the cylinder toward the inner side in the radial direction by spinning-machining toward the inner side in the radial direction. The outer housing can 16 has a tubular part 30 with the bottom including the protrusion 36, and an annular shoulder 33. The tubular part 30 with the bottom houses the electrode assembly 14 and the non-aqueous electrolyte, and the shoulder 33 is folded from an end on a side of an opening of the tubular part 30 with the bottom toward the inner side in the radial direction, and extends toward the inner side in the radial direction. The shoulder 33 is formed when an upper end of the outer housing can 16 is folded toward the inner side and is crimped on the side of a peripheral part 31 of the sealing assembly 17. With the crimping, the sealing assembly 17 is sandwiched by the shoulder 33 and an upper side of the protrusion 36, along with the gasket 28, and is fixed on the outer housing can 16.

Next, a structure of the sealing assembly 17 will be described in detail. As shown in FIG. 1, the sealing assembly 17 has a structure in which the terminal plate 23, a safety vent 24, an annular insulating member 26, and the vent cap 27, which are an example of a rupturing part, are layered in this order from the side of the electrode assembly 14. The members of the sealing assembly 17 have a circular plate shape or a ring shape, and members other than the annular insulating member 26 are electrically connected to each other. The terminal plate 23 forms a bottom plate of the sealing assembly 17, and has a circular upper surface 23a positioned on approximately the same plane. The terminal plate 23 has an annular thick part 23b positioned at an outer side in the radial direction, and a circular plate-shaped thin part 23c which is connected to an annular end of the thick part 23b on the inner side in the radial direction, and which is thinner than the thick part 23b.

The positive electrode lead 20 is connected to a lower surface of the thick part 23b of the terminal plate 23 by welding or the like. The safety vent 24 is formed by applying bend-machining or press-machining on a circular plate member made of metal and having an approximately same thickness. The safety vent 24 has a circular annular part 24a, an annular step 24b, and a circular plate part 24c. On an outer circumferential side of the circular annular part 24a, an annular protrusion 24d which protrudes in a manner to recess toward the lower side is provided, and an annular groove 34 is present above the annular protrusion 24a. The annular step 24b extends from an end at an inner side in the radial direction of the circular annular part 24a, to protrude toward the lower side. The circular plate part 24c is provided at the center part in the radial direction. The circular plate part 24c is connected to an end at a lower side of the annular step 24b, and is positioned on a plane which is approximately orthogonal to the height direction. The safety vent 24 has an upper surface 24e which has an approximate circular shape, and has an annular protrusion 24f which protrudes from an outer edge of the circular annular part 24a toward the upper side in the height direction. The safety vent 24 has a thin part 24g on which a groove of an approximately isosceles triangle shape in the cross-sectional view of FIG. 1 is provided. A reason for providing this thin part 24g will be described later.

As described, the thin part 23c of the terminal plate 23 is connected to the lower surface of the circular plate part 24c of the safety vent 24 by welding or the like, so that the terminal plate 23 is electrically connected to the safety vent 24. Desirably, the terminal plate 23 and the safety vent 24 are formed from aluminum or an aluminum alloy, as such a configuration facilitates connection of center parts of the terminal plate 23 and the safety vent 24. As a method of connection, desirably, metallurgic joining is desirably employed, and laser welding is an example of the metallurgic joining.

The annular insulating member 26 is press-fitted to an inner circumferential surface of the annular protrusion 24d, and a lower surface of the annular insulating member 26 is pressurized toward an upper side by the upper surface of the thick part 23b. The annular insulating member 26 is provided in order to secure insulating property, and prevents electrical connection of the thick part 23b of the terminal plate 23 with the safety vent 24. The annular insulating member 26 is desirably formed from a material which does not affect battery characteristics. As a material of the annular insulating member 26, a polymer resin may be employed, and there may be exemplified a polypropylene (PP) resin, and a polybutylene terephthalate (PBT) resin.

As shown in FIG. 1, the inner circumferential surface of the annular protrusion 24d may have a truncated conical shape having an inner size reduced toward the lower side, and the outer circumferential surface of the annular insulating member 26 may have a truncated conical shape corresponding to this inner circumferential surface. In this case, by press-fitting and fixing the annular insulating member 26 to the annular protrusion 24d, it becomes possible to reliably prevent positional deviation of the annular insulating member 26 with respect to the annular protrusion 24d.

The vent cap 27 forms the top plate of the sealing assembly 17, and has a circular shape in the plan view. The vent cap 27 can be fabricated, for example, by press-machining a plate member of aluminum or an aluminum alloy. Because aluminum and the aluminum alloy have superior flexibility, these materials are desirable as the material of the vent cap 27. The vent cap 27 has a vent circular part 27a, an annular bent part 27b, and a circular plate part 27c. The vent circular annular part 27a has a circular annular shape, and is provided at an outer side in the radial direction. The vent circular annular part 27a extends on a plane which is approximately orthogonal to the height direction. An outer circumferential surface of the vent circular annular part 27a contacts the inner circumferential surface of the annular protrusion 24f of the safety vent 24 by the crimping, and experiences a force toward the inner side in the radial direction, applied from the inner circumferential surface of the annular protrusion 24f. The annular bent part 27b is bent from an end at the inner side in the radial direction of the vent circular annular part 27a toward the upper side in the height direction, and protrudes toward the upper side in the height direction. The annular bent part 27b has a through hole 37. The circular plate part 27c is connected to an upper end of the annular bent part 27b, and extends on a plane approximately orthogonal to the height direction.

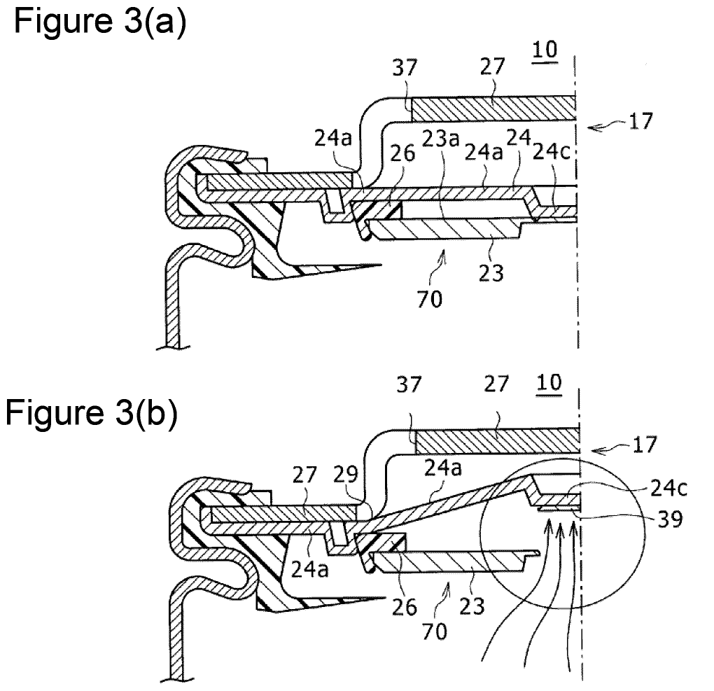

In the cylindrical battery 10 of the present embodiment, the terminal plate 23, the safety vent 24, and the annular insulating member 26 form a current breaker mechanism 70. Next, an operation of the current breaker mechanism 70 will be described. FIG. 3(a) is an enlarged cross-sectional diagram of a periphery of the sealing assembly 17 before the operation of the current breaker mechanism 70, and FIG. 3(b) is an enlarged cross sectional diagram of a periphery of the sealing assembly 17 after the operation of the current breaker mechanism 70. In FIGS. 3(a) and 3(b), illustration of the positive electrode lead 20 is omitted. As shown in FIG. 3(a), when an internal pressure of the cylindrical battery 10 is within a normal range, the upper surface 23a of the terminal plate 23 extends in a direction approximately orthogonal to the height direction. On the other hand, when heat is abnormally generated in the cylindrical battery 10 and the internal pressure of the cylindrical battery 10 is increased to a certain value or greater, as shown in FIG. 3(b), a portion of the circular annular part 24a of the safety vent 24 not in contact with the vent cap 27 is pressed upward in the height direction and is bent upward in the height direction, due to the high internal pressure, with an end of the circular annular part 24a at the inner side in the radial direction and in contact with the vent cap 27 as a fulcrum 29. In addition, simultaneously with the folding of the circular annular part 24a toward the upper side in the height direction, a fixed portion (welded portion in the case of fixation by welding) 39 of the thin part 23c of the terminal plate 23, which is fixed on the circular plate part 24c of the safety vent 24 shoots upwards along with the circular annular part 24a, and is cut out from the terminal plate 23.

With this configuration, a current path between the terminal plate 23 and the safety vent 24 is cut off. When the internal pressure is further increased, the safety vent 24 ruptures at the thin part 24g (refer to FIG. 1) having a low rigidity due to provision of a groove having the triangular cross-sectional shape, and gas passes through the safety vent 24 and is discharged to the outside through the through hole 37 of the vent cap 27. With this configuration, even when abnormal heat is generated in the cylindrical battery 10, influences of the abnormal heat generation to a device on which the cylindrical battery 10 is mounted may be suppressed or prevented, safety can be fully ensured, and damages of the device can be suppressed or prevented.

In the cylindrical battery, during the above-described crimping, an excessive force tends to be applied to the inside the safety vent including components at the inner side in the radial direction, and variation of the operation pressure of the current breaker mechanism tends to be large. In particular, in the cylindrical battery, a shape may be employed in which the circular annular part of the safety vent does not extend in the orthogonal direction orthogonal to the height direction and extends in an inclined direction with respect to the orthogonal direction, unlike the cylindrical battery 10 of FIG. 1 in which the circular annular part 24a of the safety vent 24 extends horizontally. In such a configuration, in particular, unlike the cylindrical battery 10 shown in FIG. 1, the operation pressure of the current breaker mechanism tends to significantly differ from a desired operation pressure, and the reliably of the cylindrical battery tends to be further reduced.

On the other hand, when the cylindrical battery 10 is formed using the gasket 28 of an embodiment of the present disclosure, as shown in the cylindrical battery 10 of FIG. 1, the vent circular annular part 27a of the vent cap 27 extends horizontally, and thus, the variation of the operation pressure of the current breaker mechanism 70 can be reduced and the cylindrical battery 10 having high reliability can be easily realized. Next, a structure of the gasket 28 according to an embodiment of the present disclosure which facilitates manufacture of such a highly reliable cylindrical battery 10 will be described.

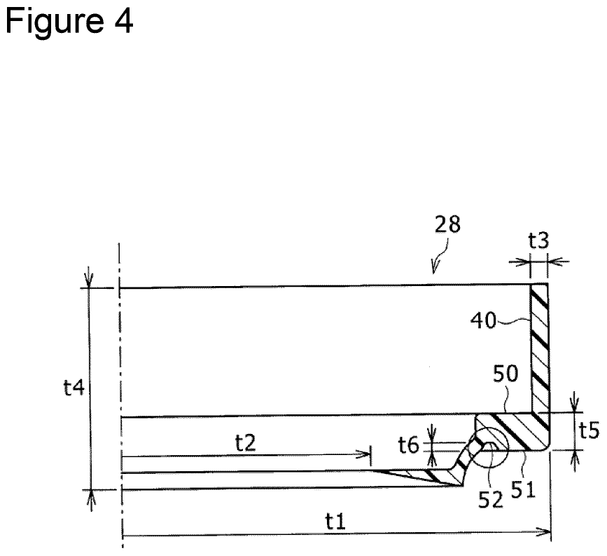

FIG. 4 is a cross-sectional diagram of a one-side portion positioned at one side of a central axis of the annular gasket 28 which facilitates formation of such a cylindrical battery 10, and is a half cross-sectional diagram showing a state before the gasket 28 is incorporated to the outer housing can 16. As shown in FIG. 4, in the singular state before being incorporated to the outer housing can 16, the gasket 28 has a tubular part 40, and a circular annular part 50 which extends from an end on a first side (lower side) in an axial direction of the tubular part 40 toward an inner side in a radial direction. The circular annular part 50 has an annular recess 52 which is recessed to a second side (upper side) in the axial direction, on an inner side in the radial direction of a surface 51 on the first side (lower side) in the axial direction.

The gasket 28 is formed from an insulating material, for example, a resin material or the like such as polypropylene. Desirably, the gasket 28 has dimensions described below in the singular state before being incorporated into the outer housing can 16, because the variation of the operation pressure of the current breaker mechanism of the cylindrical battery 10 can be suppressed more significantly with these dimensions.

Specifically, an outer size t1 of the gasket 28 is desirably 94˜98% of an outer size of the outer housing can 16, and an inner size t2 of the gasket 28 is desirably 74%˜78% of the outer housing can 16. A material thickness t3 of the tubular part 40 of the gasket 28 is desirably 1˜4% of a material thickness of the outer housing can 16. A gasket height t4 is desirably 2˜10 mm, a material thickness t5 of the circular annular part 50 (height of the circular annular part 50 in the axial direction) is desirably 17˜22% of the gasket height t4, and a depth of the recess 52 (height in the axial direction) t6 is desirably 20˜30% of the material thickness t5 of the circular annular part 50 (height of the circular annular part 50 in the axial direction). Further, it is desirable that at least a part of the recess 52 exist at a position of 80%˜88% of the outer diameter in relation to the radial direction of the gasket 28.

### [Overview of Tests]

The present inventors measured, in the following manner, the variation of the operation pressures of the current breaker mechanisms for 20 cylindrical batteries 10 manufactured using 20 gaskets satisfying the above-described dimensions, and 20 cylindrical batteries 10 manufactured using 20 gaskets differing from the above-described 20 gaskets only in that the recess 52 was not formed, and the following results were obtained.

### <Measurement of Operation Pressure of Current Breaker Mechanism>

The operation pressure was measured taking advantage of the phenomenon that the electrical resistance discretely increases when the welding part between the terminal plate and the safety vent ruptures. While the terminal plate was welded to the safety vent, a lower side of the sealing assembly was set as a tightly sealed space, and the internal pressure of the tightly sealed space was increased. While measuring the internal pressure of the tightly sealed space, the electrical resistance of the vent cap and the terminal plate when the internal pressure increased was measured. An internal pressure when the resistance value was increased by 1Ω or more was taken as the operation pressure of the current breaker mechanism.

### <Test Results>

A variation a (standard deviation) of the operation pressure of the current breaker mechanism in the cylindrical batteries manufactured using the current gaskets without the recess 52 was 0.07. On the other hand, a variation a (standard deviation) of the operation pressure of the current breaker mechanism in the cylindrical batteries 10 manufactured using the gaskets with the recess 52 was 0.03. Therefore, it was confirmed that the variation a (standard deviation) of the operation pressure of the current breaker mechanism can be significantly reduced by manufacturing the cylindrical battery using the current gasket without the recess 52.

### <Qualitative Explanation of why Variation of Operation Pressure of Current Breaker Mechanism can be Suppressed>

Next, a reason why the variation of the operation pressure of the current breaker mechanism can be suppressed in the cylindrical batteries 10 manufactured using the gaskets with the recess 52 regardless of various dimensions of the gaskets described above will be qualitatively described.

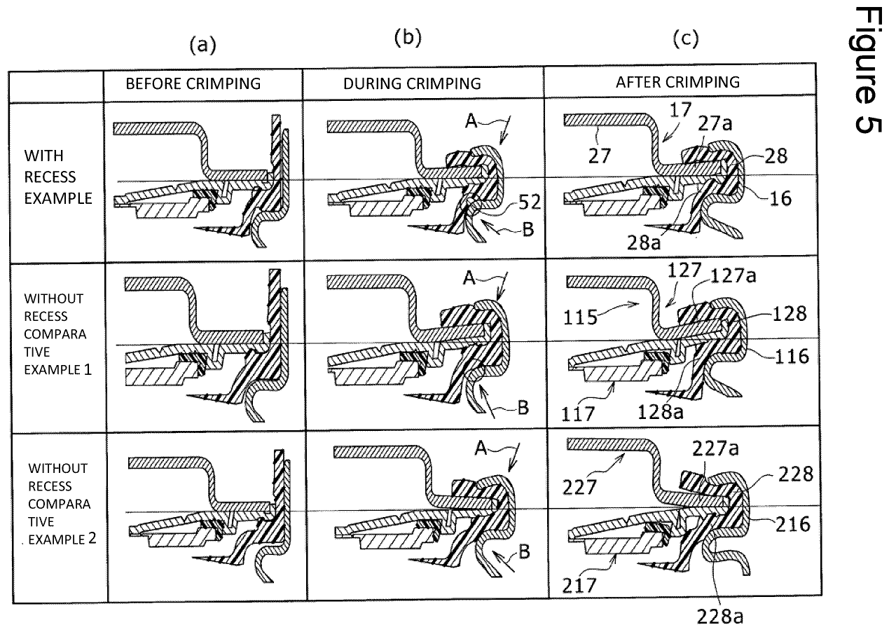

FIG. 5 is a diagram showing results of analysis using a simulation model of transition of deformation during the crimping process of gaskets 28, 128, and 228, for the gasket 28 provided with the annular recess 52, the gasket 128 of Comparative Example 1 having no recess, and the gasket 228 of Comparative Example 2 having no recess.

With reference to FIG. 5, during the crimping, a force toward a slanted lower side and toward an inner side and shown with an arrow A is applied from the shoulders of the outer housing cans 16, 116, and 216 via the gaskets 28, 128, and 228 on peripheral portions of the sealing assemblies 17, 117, and 217, respectively. Further, a force toward a slanted upper side and toward the inner side and shown with an arrow B is applied from the protrusions of the outer housing cans 16, 116, and 216 via the gaskets 28, 128, and 228 on the peripheral portions of the sealing assemblies 17, 117, and 217, respectively. In these cases, when there is no recess at the lower side on the inner side in the radial direction of the circular annular portion of the gaskets 128 and 228, as shown by the gasket 128 of Comparative Example 1 and the gasket 228 of Comparative Example 2, lower compressed portions 128a and 228a in contact with the protrusions in the gaskets 128 and 228, respectively, cannot be moved away.

Thus, when the thickness of the lower compressed portion 128a of the gasket 128 is large as in the gasket 128 of Comparative Example 1, the force in the slanted upper side and in the inner side and shown by the arrow B becomes large. As a result, as shown in the figure after the crimping, the vent circular annular part 127a of the vent cap 127 of the sealing assembly 117 tends to be more easily deflect upward, toward the outer side in the radial direction. On the other hand, when the thickness of the lower compressed portion 228a of the gasket 228 is small as in the gasket 228 of Comparative Example 2, the force in the slanted lower side and in the inner side and shown by the arrow A becomes large, and, as a result, as shown in the figure after the crimping, the vent circular annular part 227a of the vent cap 227 of the sealing assembly 217 tends to be more easily deflect downward, toward the outer side in the radial direction.

In the contrary, when the recess 52 is present at the lower side in the inner side in the radial direction of the circular annular part of the gasket 28 as in the gasket 28 of Example, because a part of the compressed portion 28a can be moved into the recess 52 during the crimping, the force in the slanted lower side and in the inner side and shown by the arrow A, and the force in the slanted upper side and in the inner side and shown by the arrow B can be reduced. Therefore, it becomes possible to suppress application of an excessive force in the slanted lower side and in the inner side or an excessive force in the slanted upper side and in the inner side on the vent circular annular part 27a of the vent cap 27 of the sealing assembly 17. As a result, as shown in the figure after the crimping in relation to Example, the vent annular circular part 27a of the vent cap 27 of the sealing assembly 17 can easily be extend in the direction orthogonal to the height direction, and, as a consequence, the variation in the operation pressure of the current breaker mechanism can be suppressed.

### <Sealing Property in Cylindrical Battery of Present Disclosure>

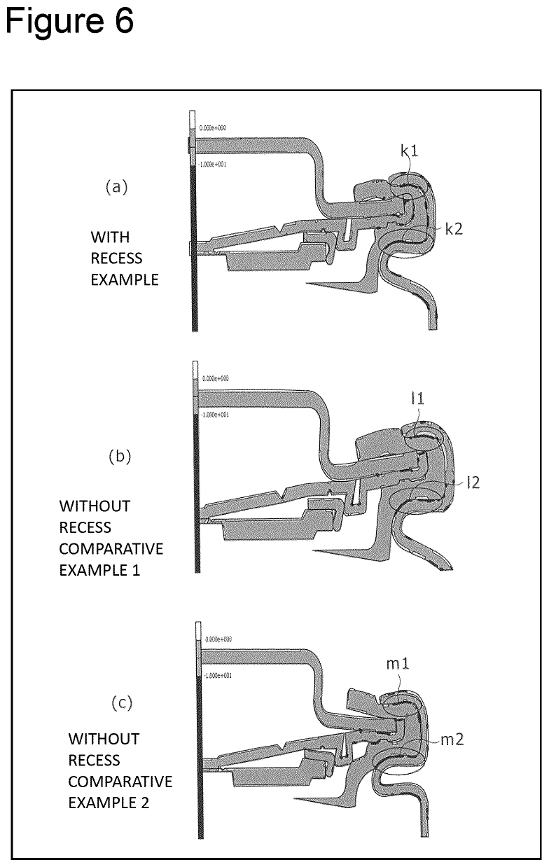

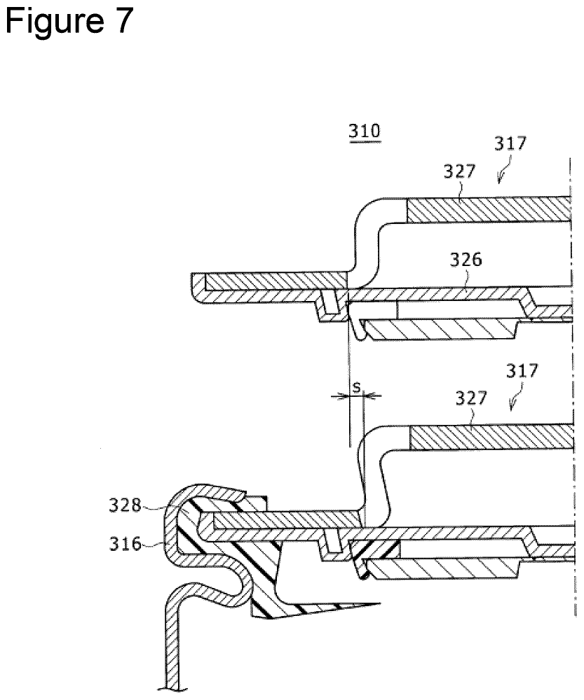

Furthermore, the present inventors have confirmed that the cylindrical battery according to the present disclosure has a superior gasket sealing property, through a stress analysis using a simulation model. FIG. 6 is a diagram showing a result of simulation, showing a stress distribution after the crimping, for the cylindrical batteries of Example, Comparative Example 1, and Comparative Example 2 used in the analysis shown in FIG. 5.

In FIG. 6, a white region shows a region of a small stress, a gray region shows a region of a middle stress, and a black region shows a region of a large stress. As shown in FIG. 6, based on the simulation result, it was confirmed that, in all of Example, Comparative Example 1, and Comparative Example 2, regions of particularly large stress k1, k2, 1, l2, m1, and m2 exist along a region between the shoulder of the outer housing can and the gasket and a region between the upper side of the protrusion of the outer housing can and the gasket. Thus, it was confirmed that, even when the recess 52 is formed at the lower side on the inner side in the radial direction of the circular annular part 50 of the gasket 28, a superior sealing property similar to that of the cylindrical battery which uses a gasket without the recess can be realized in the gasket 28 in the cylindrical battery 10.

As described, the gasket 28 is the gasket of the cylindrical battery 10. In addition, the gasket 28 comprises the tubular part 40 and the circular annular part 50 which extends from an end on a first side (lower side) in an axial direction of the tubular part 40 toward an inner side in a radial direction. Further, the circular annular part 50 has the recess 52 recessed to a second side (upper side) in the axial direction on an inner side in the radial direction of the surface 51 on the first side in the axial direction.

Therefore, the lower compressed part 28a can be moved away into the recess 52 during the crimping, and variation in the force in the inner side in the radial direction acting on the peripheral portion of the sealing assembly 17 during the crimping can be suppressed. Thus, the variation of the current breaker mechanism 70 can be reduced and a highly reliable cylindrical battery 10 can be manufactured, and a cylindrical battery 10 having a superior sealing property of the gasket 28 can be manufactured.

In the singular state before the gasket 28 is incorporated into the outer housing can 16, the dimension in the axial direction of the circular annular part 50 may be 17%˜22% of an entire length in the axial direction of the gasket 28. Further, in the singular state before the gasket 28 is incorporated into the outer housing can 16, the depth of the recess 52 may be 20˜30% of the dimension in the axial direction of the circular annular part 50. Moreover, in the singular state before the gasket 28 is incorporated into the outer housing can 16, at least a part of the recess 52 may be present at a position of 80˜88% of the outer diameter of the gasket 28 in relation to the radial direction.

With these configurations, the variation in the current breaker mechanism 70 can be further reduced, and the reliability of the cylindrical battery 10 can be further improved.

The cylindrical battery 10 comprises the electrode assembly 14 in which the positive electrode 11 and the negative electrode 12 are wound with the separator 13 interposed therebetween, the electrolyte, the outer housing can 16 having the tubular shape with the bottom and which houses the electrode assembly 14 and the electrolyte, the sealing assembly 17, and the annular gasket 28 including the sandwiched part sandwiched by the outer housing can 16 and the sealing assembly 17, and which insulates the sealing assembly 17 with respect to the outer housing can 16. The sealing assembly 17 includes the current breaker mechanism 70 having the terminal plate (rupturing part) 23 which ruptures to cut off the flow of the current. In addition, in the singular state before the gasket 28 is incorporated into the outer housing can 16, the gasket 28 has the tubular part 40 and the circular annular part 50 which extends from an end on the first side in the axial direction of the tubular part 40 toward the inner side in the radial direction, and the circular annular part 50 has the recess 52 recessed to the second side in the axial direction on the inner side in the radial direction of the surface 51 on the first side in the axial direction.

Therefore, the variation of the operation pressure in the current breaker mechanism 70 in the cylindrical battery 10 can be reduced, and the reliability can be improved.

Further, the sealing assembly 17 may have the vent cap 27 having a surface on the second side (upper side) in the axial direction exposed to the outside. The vent cap 27 may be positioned at the outer side in the radial direction of the outer housing can 16 and may have a vent circular annular part 27a having an annular shape extending in the direction approximately orthogonal to the height direction.

When the vent cap 27 has the vent circular annular part 27a having an annular shape extending in the direction approximately orthogonal to the height direction as described above, as explained with reference to FIG. 5, a force which is not excessive and which has an appropriate magnitude in the inner side in the radial direction is applied to the peripheral portion of the sealing assembly 17 during the crimping. Therefore, the variation of the operation pressure of the current breaker mechanism 70 of the cylindrical battery 10 can be significantly reduced, the reliability of the cylindrical battery 10 can be significantly improved, and the sealing property of the cylindrical battery 10 can be improved.

The present disclosure is not limited to the above-described embodiment and the alternative configurations thereof, and various improvements and modifications may be made within the scope and spirit of the present disclosure described in the claims, and equivalences thereof.

For example, while the present disclosure has been described with reference to the case in which, in the singular state before the gasket 28 is incorporated into the outer housing can 16, the dimension in the axial direction of the circular annular part 50 is 17%˜22% of the entire length in the axial direction of the gasket 28, the dimension in the axial direction of the circular annular part is not limited to 17%˜22% of the entire length in the axial direction of the gasket. Further, while the present disclosure has been described with reference to the case in which, in the singular state before the gasket 28 is incorporated into the outer housing can 16, the depth of the recess 52 is 20˜30% of the dimension in the axial direction of the circular annular part 50, the depth of the recess is not limited to 20˜30% of the dimension in the axial direction of the circular annular part. Moreover, while the present disclosure has been described with reference to the case in which, in the singular state before the gasket 28 is incorporated into the outer housing can 16, at least a part of the recess 52 is present at a position of 80˜88% of the outer diameter of the gasket 28 in relation to the radial direction, all of the recess may be present at positions other than the position of 80˜88% of the outer diameter of the gasket in relation to the radial direction.

In addition, while the present disclosure has been described with reference to the case in which the recess 52 has an annular shape, the recess provided to be recessed to the second side in the axial direction on the inner side in the radial direction of the surface on the first side in the axial direction of the circular annular part of the annular gasket does not need to have an annular shape.

For example, in the singular state before the annular gasket is incorporated into the outer housing can, a plurality of the same recesses positioned with an equal interval along the circumferential direction and recessed to the second side in the axial direction may be provided at the inner side in the radial direction of the surface on the first side in the axial direction in the circular annular part. Alternatively, a plurality of different recesses positioned with an equal interval along the circumferential direction and recessed to the second side in the axial direction may be provided.

Alternatively, in the singular state before the annular gasket is incorporated into the outer housing can, a plurality of the same recesses positioned with a unequal interval along the circumferential direction and recessed to the second side in the axial direction may be provided on the inner side in the radial direction of the surface on the first side in the axial direction of the circular annular part, or a plurality of different recesses positioned with an unequal interval along the circumferential direction and recessed to the second side in the axial direction may be provided.

Alternatively, in the singular state before the annular gasket is incorporated into the outer housing can, only one recess recessed to the second side and having a C shape in the plan view from one side in the height direction (lower side) may be provided on the inner side in the radial direction of the surface on the first side in the axial direction of the circular annular part.

That is, it is sufficient that, in the singular state before the annular gasket is incorporated into the outer housing can, one or more recesses recessed to the second side is provided on the inner side in the radial direction of the surface on the first side in the axial direction of the circular annular part, and the one or more recesses may have any form.

In addition, while the present disclosure has been described with reference to the case in which the vent circular annular part 27a of the vent cap 27 extends on a plane approximately orthogonal to the height direction (axial direction), the vent circular annular part of the vent cap in the cylindrical battery of the present disclosure may have a portion inclined with respect to the plane approximately orthogonal to the height direction (axial direction).

Further, while the present disclosure has been described with reference to the case in which the cylindrical battery 10 has the current breaker mechanism 70 which cuts off the current by rupturing the terminal plate 23, the current breaker mechanism of the cylindrical battery may be any mechanism so long as the mechanism is a mechanism which cuts off the flow of the current by rupturing the rupturing part. Therefore, the current breaker mechanism of the cylindrical battery is not limited to the mechanism described above, and may be any of various current breaker mechanisms which are known in the field, or a mechanism which cuts off the flow of the current by rupturing other rupturing parts.

### REFERENCE SIGNS LIST

10 cylindrical battery, 11 positive electrode, 12 negative electrode, 13 separator, 14 electrode assembly, 15 battery casing, 16 outer housing can, 17 sealing assembly, 18, 19 insulating plate, 20 positive electrode lead, 21 negative electrode lead, 23 terminal plate, 23a upper surface, 23b thick part, 23c thin part, 24 safety vent, 24a circular annular part, 24b step, 24c circular plate part, 24d annular protrusion, 24e upper surface, 24f annular protrusion, 24g thin part, 26 annular insulating member, 27 vent cap, 25a vent circular annular part, 27b annular bent part, 27c circular plate part, 28 gasket, 28a lower compressed part, 30 tubular part with bottom, 31 peripheral portion, 32 sandwiched part, 33 shoulder, 35 annular groove, 36 protrusion, 37 through hole, 40 tubular part, 50 circular annular part, 51 surface on first side (lower side) in axial direction of circular annular part, 52 recess, 70 current breaker mechanism.

1. A gasket for a cylindrical battery, the gasket comprising:
a tubular part; and
a circular annular part that extends from an end on a first side in an axial direction of the tubular part toward an inner side in a radial direction, wherein
the circular annular part has a recess which is recessed to a second side in the axial direction, on an inner side in the radial direction of a surface on the first side in the axial direction.

2. The gasket according to claim 1, wherein
a dimension of the circular annular part in the axial direction is 17%˜22% of an entire length in the axial direction.

3. The gasket according to claim 1, wherein
a depth of the recess is 20˜30% of the dimension of the circular annular part in the axial direction.

4. The gasket according to claim 1, wherein
at least a part of the recess is present at a position of 80˜88% of an outer diameter in relation to the radial direction.

5. A cylindrical battery comprising:
an electrode assembly in which a positive electrode and a negative electrode are wound with a separator interposed therebetween;
an electrolyte;
an outer housing can having a tubular shape with a bottom and that houses the electrode assembly and the electrolyte;
a sealing assembly, and
an annular gasket that includes a sandwiched part which is sandwiched by the outer housing can and the sealing assembly, and that insulates the sealing assembly with respect to the outer housing can, wherein
the sealing assembly includes a current breaker mechanism having a rupturing part which ruptures to cut off a flow of current, and
in a singular state before the gasket is incorporated into the outer housing can, the gasket has a tubular part, and a circular annular part which extends from an end on a first side in an axial direction of the tubular part toward an inner side in a radial direction, wherein the circular annular part has a recess which is recessed to a second side in the axial direction, on an inner side in the radial direction of a surface on the first side in the axial direction.

6. The cylindrical battery according to claim 5, wherein
the sealing assembly has a vent cap having a surface on the second side in the axial direction exposed to outside, and
the vent cap is positioned at an outer side in a radial direction of the outer housing can, and has a vent circular annular part having an annular shape and which extends in a direction approximately orthogonal to a height direction.
